(19) United States
(12) Patent Application Publication
(10) Pub. No.: US 2026/0367978 A1
(43) Pub. Date: Nov. 19, 2026

(54) Provisioning Hardware Subcomponents In Parallel

(71) Applicant: Oracle International Corporation, Redwood Shores, CA (US)

(72) Inventors: Ashok Prakash, Renton, WA (US); Amith Kumar Nuggehalli Ramachandra, King County, WA (US); Manikarthik Konakalla, Snohomish County, WA (US); Gyanesh Sharma, Seattle, WA (US)

(73) Assignee: Oracle International Corporation, Redwood Shores, CA (US)

(21) Appl. No.: 19/208,108

(22) Filed: May 14, 2025

(51) Int. Cl. G06F 9/50

(52) U.S. Cl. CPC G06F 9/5027

(57) ABSTRACT

Techniques for provisioning hardware subcomponents in parallel are disclosed. A system accesses resource requirement information that indicates dependency relationships between actions associated with jobs and resource states of respective hardware resources. The system determines that a first action of a first job is dependent on a particular resource state of a hardware resource, and that a second action of a second job is dependent on the same resource state of the hardware resource. The system executes the second action concurrently with the first action based on determining that (a) executing the first job is not dependent on completion of the second job and (b) the first action and the second action do not depend on different resource states of the hardware resource.

### TECHNICAL FIELD

The present disclosure relates to cloud computing data centers. In particular, the present disclosure relates to provisioning bare metal system subcomponents in parallel.

### BACKGROUND

A cloud service provider may sell access to computing infrastructure (e.g., processors, network hardware, storage devices, etc.) to one or more client entities (e.g., an individual, business, educational institution, etc.). The infrastructure may include virtual resources that do not exactly mirror the underlying hardware. For example, a virtual storage volume may be backed by multiple underlying storage devices. Additionally, or alternatively, the infrastructure may include one or more designated physical computer systems. For example, a cloud service provider may sell access to a server hosted in a data center. A designated physical computer system is referred to herein as a “bare metal system.”

Before making a bare metal system available to a client entity, or when the client entity no longer needs the bare metal system, the cloud service provider may provision or reprovision the bare metal system. Provisioning the bare metal system may include provisioning multiple hardware components of the bare metal system. For example, provisioning may include (a) removing software installed for a previous client, b) clearing data installed for the previous client and (c) installing a particular set of firmware and drivers. A provisioning process may include many different kinds of operations, such as clearing storage media, reinstalling an operating system, installing a particular firmware version on a motherboard or graphical processing unit (GPU), etc. When provisioning operations are performed sequentially, the total amount of time needed is at least the sum of the times taken to provision each individual component. For example, the time needed to provision one GPU is roughly one eighth of the time needed to provision eight GPUs. During the provisioning process, the bare metal system is unavailable for use by client entities.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIG. 1 illustrates a system in accordance with one or more embodiments;

FIGS. 2A illustrates an example set of operations for provisioning hardware subcomponents in parallel in accordance with one or more embodiments;

FIG. 2B illustrates an example set of operations for generating a set of resource requirement information in accordance with one or more embodiments;

FIG. 2C illustrates an example set of operations for executing a job action in accordance with one or more embodiments;

FIG. 3 illustrates an example of job dependency information in accordance with one or more embodiments;

FIG. 4 illustrates an example of subcomponent information in accordance with one or more embodiments;

FIG. 5 illustrates an example of resource requirement metadata in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PARALLEL PROVISIONING ARCHITECTURE
3. PROVISIONING HARDWARE SUBCOMPONENTS IN PARALLEL
4. EXAMPLE EMBODIMENT
5. PRACTICAL APPLICATIONS, ADVANTAGES, AND IMPROVEMENTS
6. COMPUTER NETWORKS AND CLOUD NETWORKS
7. HARDWARE OVERVIEW
8. MISCELLANEOUS; EXTENSIONS

### 1. GENERAL OVERVIEW

A provisioning system provisions or reprovisions the hardware subcomponents on a bare metal system. The provisioning process includes one or more jobs, and a job includes one or more actions. A particular action may require a particular hardware resource to be in a particular state. For example, an action that installs a software patch may require an active network connection to download the patch from a repository. When different jobs for configuring the same hardware subcomponent do not depend on each other, the system can execute the jobs in parallel.

One or more embodiments can also execute actions in parallel, if the actions do not have conflicting resource requirements. In an embodiment, the provisioning system generates metadata that maps hardware resources to the resource states needed by respective actions within a job, based on a job dependency graph and resource requirement information. An action that requires a hardware resource to be in a particular state can run in parallel with another action if the other action (a) does not require the hardware resource to be in any particular state or (b) requires the hardware resource to be in the same state, such that the two actions do not have conflicting resource requirements.

One or more embodiments use a resource tracking system to avoid conflicts over shared resources in a bare metal system being provisioned. The resource tracking system stores information about resource states. When an action requires a resource to be in a particular state, the system checks the resource tracking system to determine if the resource is in a state that satisfies the requirement of the action. If the resource is not in the required state, the provisioning system defers the action until the resource is available and/or in the required state.

One or more embodiments described in this Specification and/or recited in the claims may not be included in this General Overview section.

### 2. Parallel Provisioning Architecture

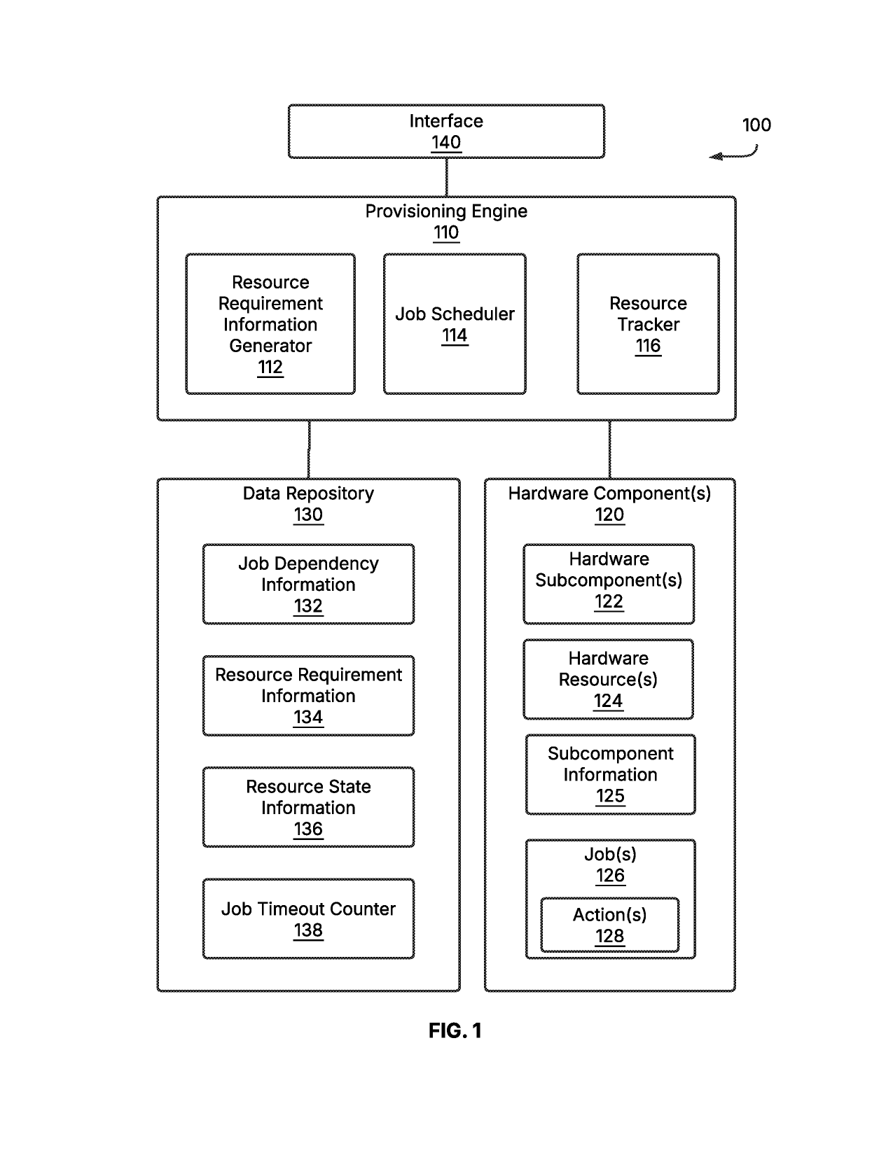

FIG. 1 illustrates a system 100 in accordance with one or more embodiments. As illustrated in FIG. 1, system 100 includes a provisioning engine 110, a data repository 130, and an interface 140. The system 100 may operate on one or more hardware components 120. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

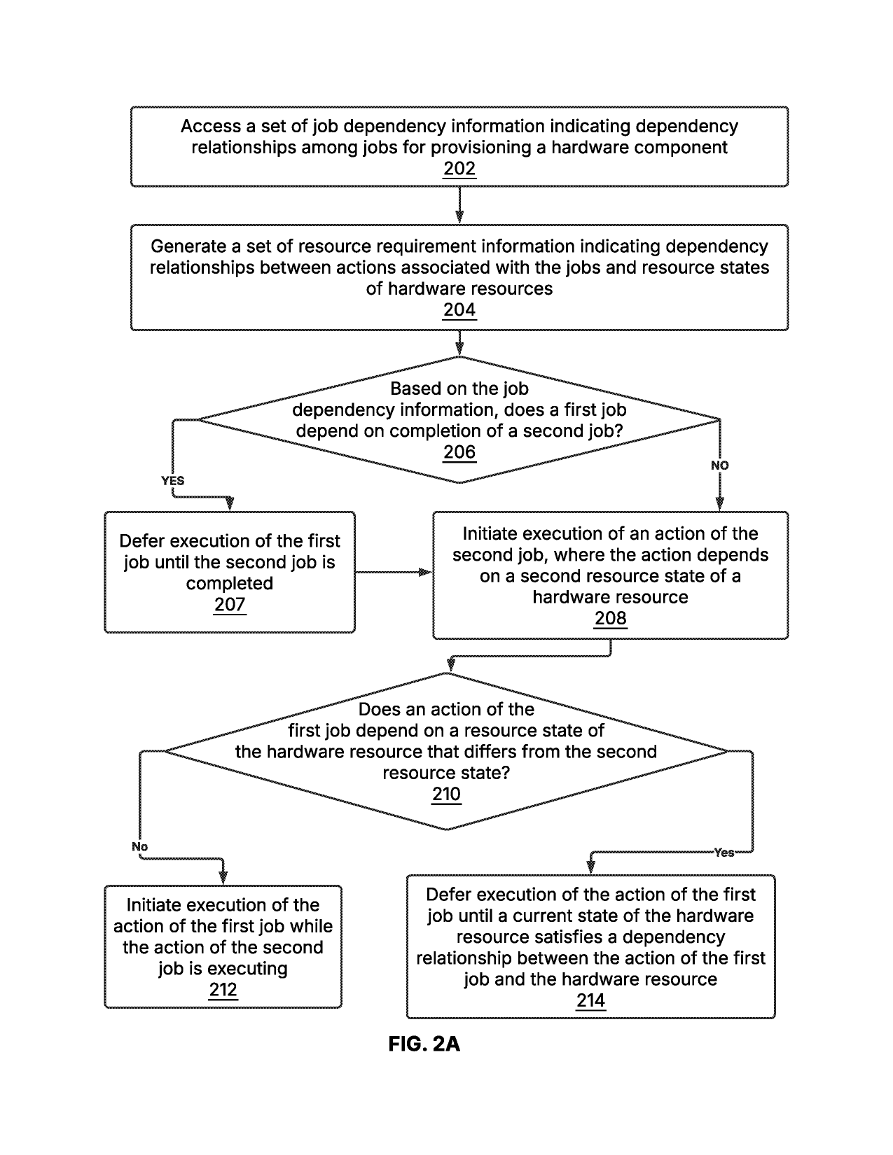

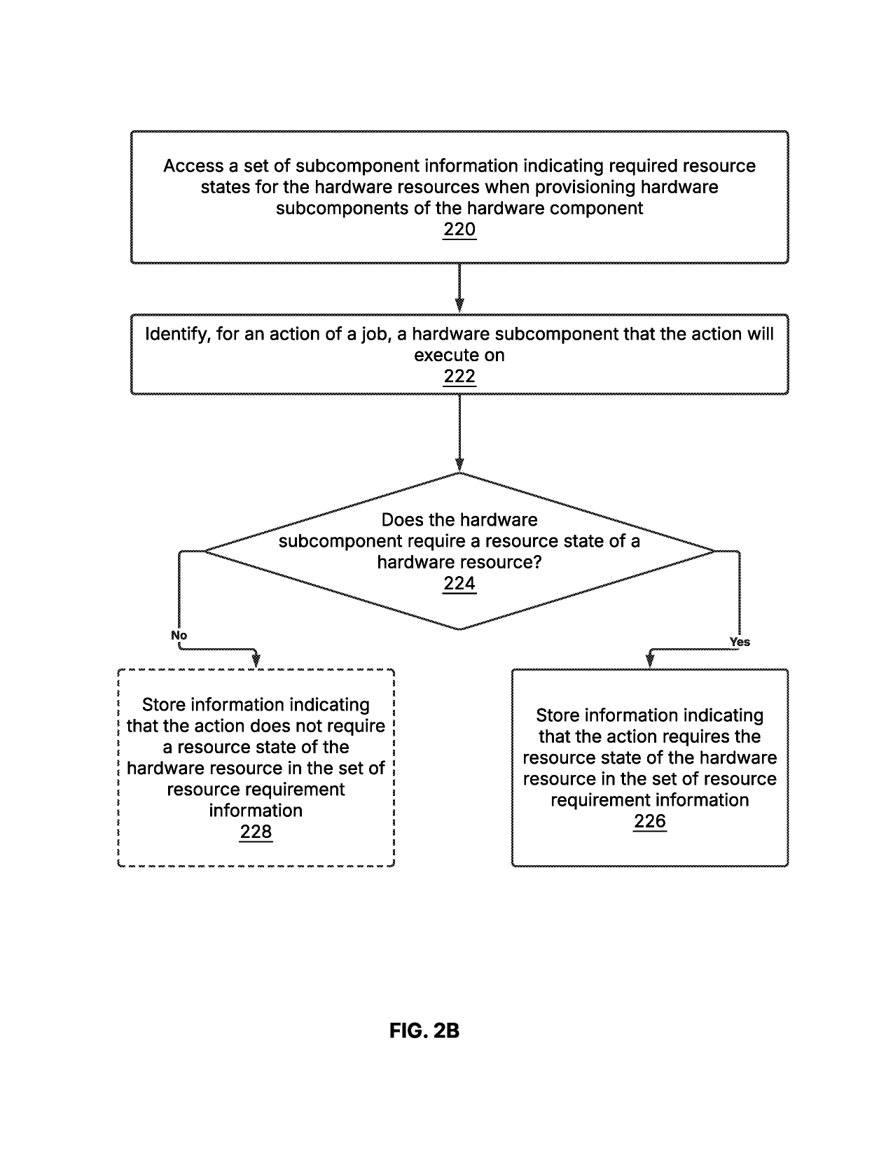

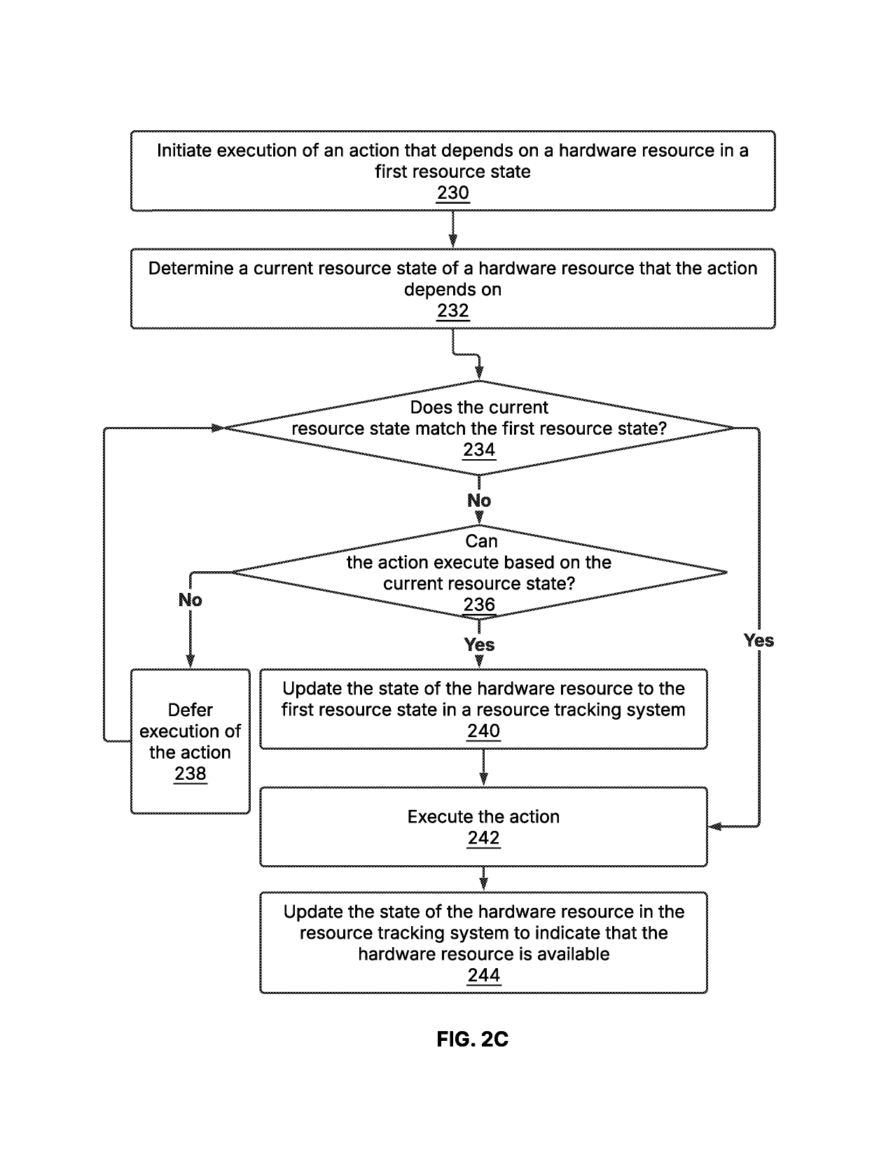

In one or more embodiments, the provisioning engine 110 refers to hardware and/or software configured to perform operations described herein for provisioning hardware subcomponents in parallel. Examples of operations for provisioning hardware subcomponents in parallel are described below with reference to FIGS. 2A-C.

In one or more embodiments, the provisioning engine 110 provisions or reprovisions one or more hardware components 120. Provisioning or reprovisioning a hardware component includes operations that prepare the hardware component for use or reuse in a data center, such as erasing and/or formatting storage devices, installing or updating firmware and drivers, configuring network settings, and installing operating system and other software.

In an embodiment, hardware component 120 refers to a bare metal system. The bare metal system may include various hardware subcomponents 122, e.g., a central processing unit (CPU), a graphics processing unit (GPU), a root of trust (RoT) device, a network interface card (NIC), volatile memory, non-volatile memory, a storage device, buses, switches, fans, communication cables, and so forth. In one example, the bare metal system is a server in a data center.

In another embodiment, hardware component 120 refers to a hardware component within a computer system. For example, hardware component 120 may be a GPU. Continuing the example of a GPU, hardware subcomponents 122 may include memory, firmware, output interfaces, and such. In this example, system 100 may perform provisioning tasks on subcomponents of the GPU in parallel. One or more embodiments may use a similar approach to provisioning other kinds of hardware subcomponents 122.

Hardware resources 124 refer to subcomponents of a hardware component that are used by a configuration job. Examples include a host power, an NIC power, a cable for a network connection, a head node box power, and a tail node box power.

Subcomponent information 125 indicates, for respective hardware subcomponents, the required resource state of a hardware resource that a hardware subcomponent depends on during configuration. For example, a subcomponent may require that the host power be off for some configuration actions. A subcomponent may require that a network interface card (NIC) power be on. In another example, a subcomponent may require that a network cable that connects the subcomponent to another subcomponent not be in use by still another subcomponent. A tail node box including a GPU may require that the head node box containing a CPU be powered on for some configuration actions. For some hardware resources, a resource state may also include a capacity constraint associated with the resource. A network-related hardware resource, for example, may have a bandwidth limit.

A job 126 refers to an atomic set of one or more actions 128 performed on a hardware subcomponent as a part of a provisioning process for the hardware subcomponent. One example of a job is a wipe job, where data is erased from a storage subcomponent. Another example of a job is a firmware installation job, where firmware is installed onto a subcomponent. An action 128 corresponds to one step in a job. An action 128 may be a set of one or more lines of code, a function or module, or other set of instructions.

In one or more embodiments, the provisioning engine 110 may include one or more functional components to enable parallelization of at least some of the configuration operations. For example, the functional components may include a resource requirement information generator 112, a job scheduler 114, and a resource tracker 116.

In one or more embodiments, the resource requirement information generator 112 refers to hardware and/or software configured to generate resource requirement information 134. Resource requirement information 134 may include information for an action of a job that indicates a particular hardware resource and a resource state that the action depends on for correct operation. The resource requirement information generator 112 may access subcomponent information 125 for the hardware subcomponents 122 of a hardware component 120 to determine the hardware resources 124 that a hardware subcomponent requires during provisioning and the resource states required for the hardware resources. The resource requirement information generator 112 may access the jobs that provision or reprovision a hardware component to determine what hardware subcomponents the individual actions in a job will act upon. The resource requirement information generator 112 may map an action in a job to a hardware resource requirement.

The resource requirement information generator 112 may generate resource requirement information 134 once for a given hardware component or hardware subcomponent, for example, when a new hardware component or new hardware subcomponent is introduced to the system. The resource requirement information 134 may then be stored for reuse, for example, as a table, a database, or a dependency graph.

In one or more embodiments, the job scheduler 114 refers to hardware and/or software configured to identify a set of jobs that are independent of other jobs and that could be run in parallel. The job scheduler 114 may access job dependency information 132 to identify one or more jobs that could be executed simultaneously. Job dependency information 132 indicates if a particular job depends on the completion of another job before the particular job can execute. The job dependency information 132 may be associated with configuration information for a hardware subcomponent.

The job dependency information 132 may be a dependency graph having jobs as nodes and directed edges between two nodes for jobs that have a dependency relationship. A directed edge may point from a first job to a second job to indicate that the second job depends on completion of the first job. The direction of the edge correlates to an order of execution. Alternatively, a directed edge may point from the second job to the first job to indicate that the second job depends on completion of the first job. The direction of the edge, when followed from the second job, indicates the job that needs to be completed so that the second job can execute.

The job dependency information 132 can be stored in a database, where a database entry for a job can include a field identifying a set of jobs that depend on the job, and another field indicating another set of jobs that the job depends on. The job dependency information 132 can be stored in a table or spreadsheet, where an entry for a job can include a cell identifying a set of jobs that depend on the job, and another cell indicating another set of jobs that the job depends on.

The job scheduler 114 may initiate the execution of the jobs in the identified set of jobs. Alternatively, a job may request permission or confirmation from the job scheduler 114 that the job may begin execution, where the permission or confirmation is at least based on job dependency information 132.

In one or more embodiments, the resource tracker 116 refers to hardware and/or software configured to track the current state(s) of one or more hardware resources 122 associated with a hardware component that the system is provisioning. The resource tracker 116 may be a database, for example. The resource tracker 116 may store an indication of the current state for a hardware resource in resource state information 136. A job or a job action may query the resource tracker 116 for a current state of a hardware resource that the job or job action depends on. A job or a job action may change or update the state of a hardware resource in the resource tracker 116.

In some cases, a job may be governed by a setting that indicates a maximum amount of time for a job to complete. The system may maintain a job timeout counter 138 for the job and may terminate the job when the timeout counter expires. To avoid prematurely terminating a job that is waiting for an unavailable resource, the system may pause the job timeout counter 138 until the resource is available, and the job can resume.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, a data repository 120 is any type of storage unit and/or device (e.g., a file system, database, collection of tables, or any other storage mechanism) for storing data. Furthermore, a data repository 120 may include multiple different storage units and/or devices. The multiple different storage units and/or devices may or may not be of the same type or located at the same physical site. Furthermore, a data repository 120 may be implemented or executed on the same computing system as the provisioning engine 110. Additionally, or alternatively, a data repository 120 may be implemented or executed on a computing system separate from the provisioning engine 110. The data repository 120 may be communicatively coupled to the provisioning engine 110 via a direct connection or via a network.

Information describing job dependencies, resources, and resource requirements may be implemented across any of components within the system 100. However, this information is illustrated within the data repository 120 for purposes of clarity and explanation.

In one or more embodiments, interface 140 refers to hardware and/or software configured to facilitate communications between a user and the provisioning engine 110. Interface 140 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 140 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 140 is specified in one or more other languages, such as Java, C, or C++.

### 3.Provisioning Hardware Subcomponents in Parallel

FIG. 2A illustrates an example set of operations for provisioning hardware subcomponents in parallel in accordance with one or more embodiments. One or more operations illustrated in FIG. 2A may be modified, rearranged, or omitted. Accordingly, the particular sequence of operations illustrated in FIG. 2A should not be construed as limiting the scope of one or more embodiments.

In an embodiment, the system accesses a set of job dependency information that indicates dependency relationships among jobs for provisioning a hardware component (Operation 202). The system may read configuration information for the hardware component or for the hardware subcomponents that make up the hardware component to identify job dependency information. The system may access separate files that include job dependency information for the hardware component or for the hardware subcomponents that make up the hardware component to identify job dependency information. The system may access firmware for a hardware subcomponent to identify job dependency information for the jobs associated with the hardware subcomponent.

In an embodiment, the system generates a set of resource requirement information that indicates dependency relationships between actions associated with the jobs and resource states of hardware resources (Operation 204). The system may access information about the hardware resources that a hardware subcomponent uses or requires during configuration operations along with required states of the hardware resources. The system may also access information about the hardware subcomponent(s) that a job will operate on. The system may use the accessed information to identify the hardware resource(s) and resource state(s) that the actions within a job will need for execution. An example of generating the set of resource requirement information is described further below with reference to FIG. 2B.

In an embodiment, the system determines if a first job depends on a second job (Operation 206). The system may select one or more jobs from a set of jobs to be executed in a provisioning or reprovisioning process. The system may determine, for a given job, if that job depends on the completion of another job or if another job depends on completion of the given job.

In an embodiment, if the first job depends on the second job, the system defers execution of the first job until the second job is completed (Operation 207). The system may, for example, place the first job in a queue for later execution. The system may set a flag or other indicator associated with the first job to indicate that the first job is not completed and/or that the first job is waiting on the second job to complete.

In an embodiment, if the first job does not depend on the second job or while the first job is deferred, the system initiates execution of an action of the second job, where the action of the second job depends on a second resource state of a hardware resource (Operation 208). For the purpose of illustration, the hardware resource is assumed to be in the second resource state. Operations for executing actions when a hardware resource is not in a required state are discussed below with reference to FIG. 2C. The system may execute instructions of the action of the second job on the hardware subcomponent that the job is provisioning.

In an embodiment, while the second action of the second job is executing, the system determines if a first action, of the first job, depends on a resource state of the hardware resource that differs from the second resource state (Operation 210). The system may check the set of resource requirement information for the hardware resource and resource state, if any, that the action of the first job requires. The system may compare the required hardware resource and resource state of the action of the first job to the required hardware resource and resource state of the action of the second job.

In an embodiment, if the action of the first job does not depend on a resource state that differs from the second resource state, the system initiates execution of the action of the first job while the action of the second job is executing (Operation 212). The system may determine that the action of the first job does not depend on a hardware resource. The system may determine that the required hardware resource and resource state of the action of the first job is the same as the required hardware resource and resource state of the action of the second job. The system may determine that the required hardware resource and a current resource state of the hardware resource satisfies a dependency relationship between the action of the first job and the hardware resource. Accordingly, the system may allow the action of the first job to execute or may initiate execution of the action of the first job while the action of the second job is already executing.

In an embodiment, if the action of the first job does require a resource state that differs from the second resource state for the hardware resource, the system defers execution of the first action until a current state of the hardware resource satisfies a dependency relationship between the first action and the hardware resource (Operation 214). The system may, for example, place the action of the first job, or the whole first job, in a queue. When the action of the second job has completed execution, or when the action of the second job no longer requires the hardware resource, the system may change the resource state of the hardware resource. Once a current resource state of the hardware resource satisfies a dependency relationship between the action of the first job and the hardware resource, the system may execute the action of the first job.

In an embodiment, even if the action of the first job does not depend on a resource state that differs from the second resource state, the system may defer execution of the action of the first job. For example, if the hardware resource in a first resource state also has a capacity constraint, the system may determine that the hardware resource is not available to the action of the first job if executing the action would exceed the capacity constraint.

In an embodiment, the system may pause a job timeout counter for the first job while execution of the action of the first job is deferred. The system may resume the job timeout counter when the current resource state of the hardware resource satisfies the dependency relationship between the action of the first job and the hardware resource. The system may resume the job timeout counter when the action of the first job resumes execution.

While the action of the first job and the action of the second job could be executed concurrently, the system might not be able to execute the action of the first job. For example, if the action of the first job requires a second hardware resource, and the resource state of the second hardware resource does not satisfy a dependency relationship between the action of the first job and the second hardware resource, the system may defer execution of the action of the first job.

FIG. 2B illustrates an example set of operations for generating a set of resource requirement information in accordance with one or more embodiments. One or more operations illustrated in FIG. 2B may be modified, rearranged, or omitted. Accordingly, the particular sequence of operations illustrated in FIG. 2B should not be construed as limiting the scope of one or more embodiments.

In an embodiment, the system accesses a set of subcomponent information indicating required resource states for the hardware resources when provisioning hardware subcomponents of the hardware component (Operation 220). The system may access subcomponent information for a hardware subcomponent of a hardware component to determine the hardware resources that the hardware subcomponent requires during provisioning and the resource states required for the hardware resources.

In an embodiment, the system identifies, for an action of a job, a hardware subcomponent that the action will execute on (Operation 222). The system may access an action in a job that provisions or reprovisions the hardware component to determine what hardware subcomponents the action will act upon. The system may identify the hardware subcomponent based on a set of code indicating operations to be performed for the action.

In an embodiment, the system determines if the hardware subcomponent depends on a resource state of a hardware resource (Operation 224). The system may refer to the subcomponent information for the hardware resource requirements, if any, of the hardware subcomponent that the action will act upon.

In an embodiment, if the hardware subcomponent depends on a resource state of a hardware resource, the system stores information indicating that the action is dependent on the resource state of the hardware resource in the set of resource requirement information (Operation 226). The system may include an entry in the set of resource requirement information for the action and link the action to a hardware resource and to a resource state. The system may, for example, add a row to a table for the action, a database entry for the action, or a node to a dependency graph for the action.

In an embodiment, if the hardware subcomponent does not depend on a resource state of a hardware resource, the system may optionally store information indicating that the action is not dependent on a resource state of the hardware resource in the set of resource requirement information (Operation 228). The system may include an entry in the set of resource requirement information for the action without linking the action to a hardware resource or to a resource state.

In an embodiment, the system may repeat the operations for additional actions in a job, for additional jobs associated with a hardware component, and for additional hardware components.

FIG. 2C illustrates an example set of operations for executing a job action in accordance with one or more embodiments. One or more operations illustrated in FIG. 2C may be modified, rearranged, or omitted. Accordingly, the particular sequence of operations illustrated in FIG. 2C should not be construed as limiting the scope of one or more embodiments.

In an embodiment, the system initiates execution of an action that depends on a hardware resource in a first resource state (Operation 230). The system may access code that includes operations to be performed for the action. The system may load an instruction for execution.

In an embodiment, the system determines a current resource state of a hardware resource that the action depends on (Operation 232). The system may access the resource requirement information corresponding to the action to identify the hardware resource that the action depends on and the state of the hardware resource that the action requires. The system may access the resource state information to determine the current state of the hardware resource.

In an embodiment, the system determines if the current resource state matches the first resource state (Operation 234). The system may compare the current state to the required state for the action. For example, if the action requires a “power on” state for an NIC and the current state for the NIC is “power on”, then the system determines that the states match.

In an embodiment, if the resource states do not match, the system determines if the action can execute based on the current resource state (Operation 236). The system may determine that the action can execute even if the current state does not match the required state if the current state satisfies the dependency requirement of the action for the hardware resource. For example, a current state for the NIC power hardware resource may be “available,” “unlocked,” or “idle”, meaning that the NIC power is not in use by another action. The system can determine that the action can execute and use the NIC power. Alternatively, the system may determine from the resource state information that the hardware resource is not in use by an action, for example, from an indicator or flag associated with the hardware resource, even if the current resource state is set to a specific state such as “power on”.

In an embodiment, if the action cannot execute based on the current resource state, the system defers execution of an action (Operation 238). The system may queue the action or may otherwise remove the operations for the action from an execution process. The system may periodically return to Operation 234 to determine if the deferred action can execute.

In an embodiment, if the action can execute based on the current resource state, the system updates the state of the hardware resource to the first resource state in the resource state information (Operation 240). For example, the system may update an “available” state for the NIC to be “power on.” Updating the current state may prevent other actions that require a different or mutually exclusive state from executing. Updating the current state from an “available” state to the required first resource state prevents other actions from changing the resource state to a different resource state while the action is executing, acting analogously to a lock on the hardware resource. Other actions that require the same resource state for the hardware resource may still be able to execute simultaneously with the action.

In an embodiment, the system executes the action (Operation 242). The system may execute code that includes operations to perform the action.

In an embodiment, the system updates the state of the hardware resource in the resource tracking system to indicate that the hardware resource is available (Operation 244). The system may return the state of the hardware resource to the state of the resource prior to the update in Operation 240. Alternatively, the system may set an indicator or flag to indicate that the hardware resource is not in use or that the current state of the hardware resource may be changed.

When a group of two or more actions have the same requirement for a particular hardware resource, the system may use sequential execution criteria to determine a sequence of execution for the actions in the group. The system may, for example, identify a constraint on a hardware resource, such as an amount of power or a bandwidth needed by an action, and determine if the hardware resource can supply the needed amount. The system may execute some of the actions sequentially rather than concurrently, so the constraints are not exceeded.

When a group of two or more actions are using a hardware resource in the first resource state simultaneously, the system may prevent the actions from updating the state of the hardware resource to indicate availability until the last of the actions in the group no longer requires the first resource state. The system may, for example, maintain respective indicators for the respective actions in the group for the hardware resource. When the last of the indicators is set to indicate that the hardware resource is available, the system may then allow the current state of the hardware resource to be updated.

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

FIG. 3 illustrates an example of job dependency information in accordance with one or more embodiments. There are four jobs in the illustrated example. Job A includes two actions, A.1 and A.2. Job B includes two actions, B.1 and B.2. Job C includes two actions, C.1 and C.2. Job D includes one action, D.1. Job A does not depend on another job, and no job depends on Job A. Job B does not depend on another job. Job C and Job D both depend on the completion of Job B but do not depend on one another. Accordingly, Job A and Job B could execute in parallel based on the dependencies. Job C and Job D could also execute in parallel with each other once Job B is complete. Job C and/or Job D could also execute in parallel with Job A once Job B is complete.

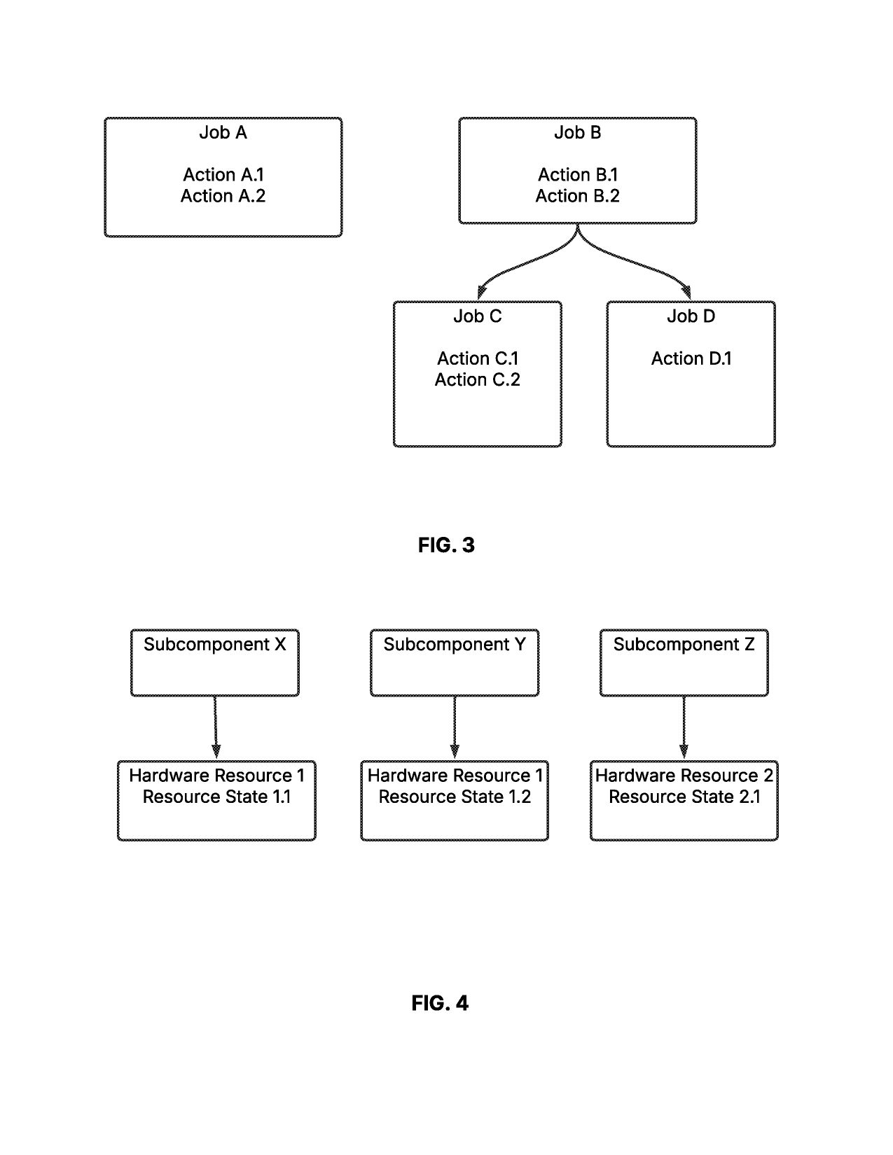

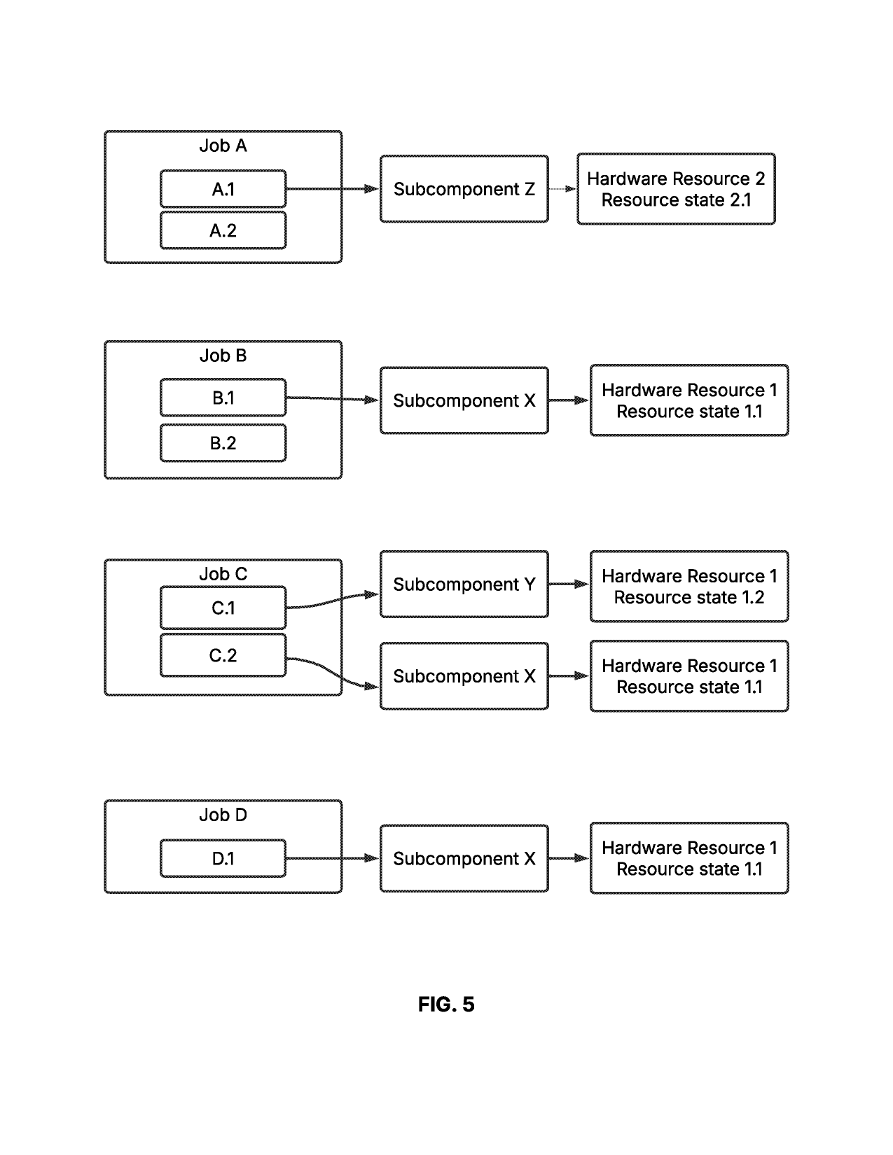

FIG. 4 illustrates an example of subcomponent information in accordance with one or more embodiments. There are three hardware subcomponents in the illustrated example: Subcomponent X, Subcomponent Y, and Subcomponent Z. Subcomponent X requires a Hardware Resource 1 in Resource State 1.1 during configuration. Subcomponent Y requires Hardware Resource 1 in Resource State 1.2 during configuration. Subcomponent Z requires a Hardware Resource 2 in Resource State 2.1 during configuration.

FIG. 5 illustrates an example of resource requirement metadata that the system may generate from the job dependency information, subcomponent information, and the resource requirement information in accordance with one or more embodiments. Based at least in part on the hardware subcomponent that an action in a job will operate on, the system determines the hardware resource and resource state that an action will require during execution.

In the illustrated example, Action A.1 of Job A operates on Subcomponent Z and therefore requires that Hardware Resource 2 be in Resource State 2.1. Action B.1 of Job B operates on Subcomponent X and therefore requires that Hardware Resource 1 be in Resource State 1.1. Action C.1 of Job C operates on Subcomponent Y and therefore requires that Hardware Resource 1 be in Resource State 1.2. Action C.2 of Job C operates on Subcomponent X and therefore requires that Hardware Resource 1 be in Resource State 1.1. Action D.1 of Job D operates on Subcomponent X and therefore requires that Hardware Resource 1 be in Resource State 1.1. The resource requirement metadata includes the information associating an action to a hardware subcomponent and to a hardware resource and resource state.

In this example, based on the job dependency information, the system executes Job C and Job D in parallel. However, because Action C.1 and Action D.1 require different resource states for the same hardware resource, the system defers one action while executing the other action. Once Action C.1 no longer requires the Resource State 1.2 for Hardware Resource 1, the system executes Action C.2 and Action D.1 concurrently.

### 5. Practical applications, Advantages, and Improvements

One or more embodiments improve the functioning of a computer system by reducing the amount of time needed to provision or reprovision a hardware component. For ease of discussion, in this section, the hardware component is assumed to be a bare metal system in a data center. As discussed above, embodiments are not limited to this example.

Specifically, one or more embodiments provide a technical solution to the technical problem that when provisioning operations are performed sequentially, the total amount of time needed is at least the sum of the times taken to provision each individual component, during which the bare metal system is unavailable for use by client entities. One or more embodiments address this technical problem by performing at least some provisioning actions in parallel, reducing the total amount of time needed to complete the provisioning as a whole. Faster provisioning reduces the amount of time the bare metal system is unavailable for use. Thus, one or more embodiments improve the functioning of the computer system (e.g., data center) by bringing bare metal servers online more quickly.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

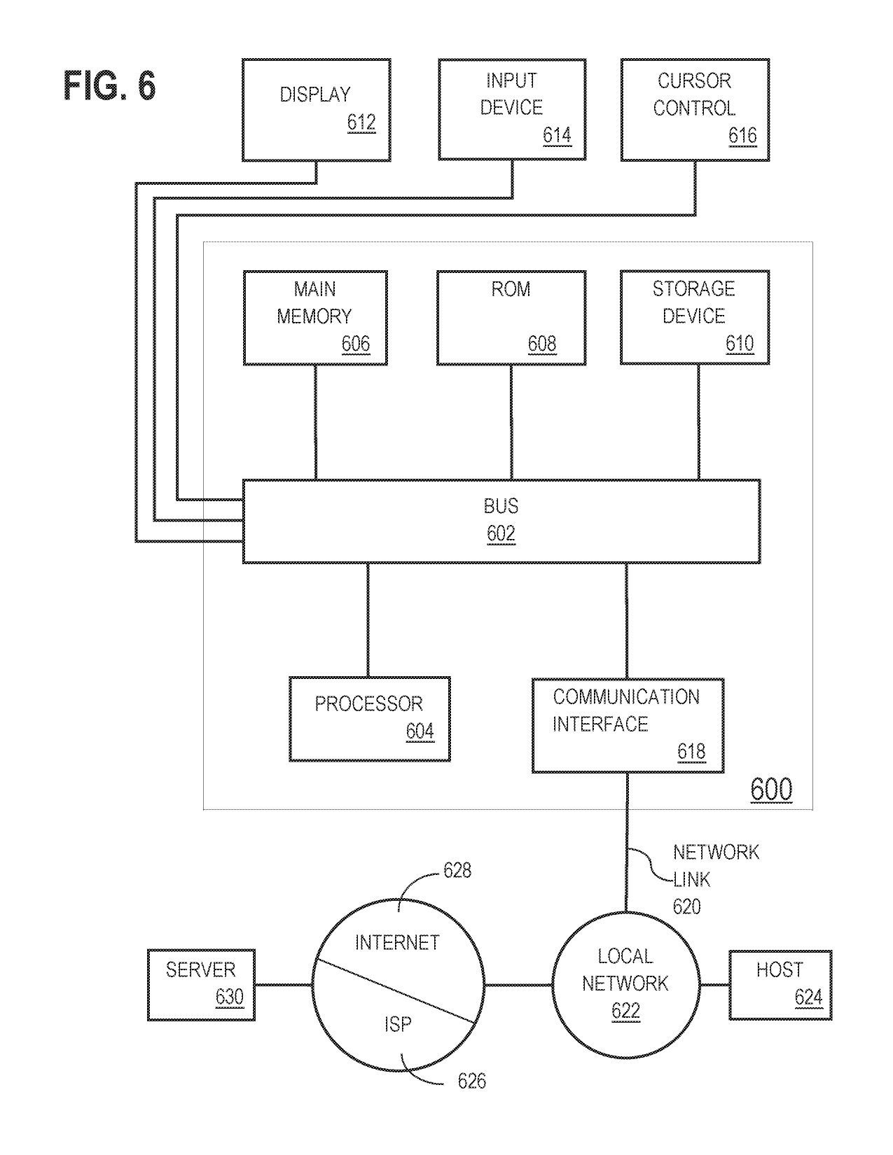

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid-State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
accessing a first set of job dependency information indicating dependency relationships among a first plurality of jobs for provisioning a hardware component in a plurality of hardware components of a computer system, wherein the first set of job dependency information indicates that executing a first job of the first plurality of jobs is not dependent on completion of a second job of the first plurality of jobs;
accessing a first set of resource requirement information indicating dependency relationships between a first plurality of actions associated with the first plurality of jobs and a plurality of resource states of a plurality of hardware resources, wherein the first set of resource requirement information indicates that
(a) a first action of the first job is dependent on a first resource state of a first hardware resource in the plurality of hardware resources, and
(b) a second action of the second job is dependent on the first resource state of the first hardware resource;
provisioning a first instance of the hardware component, wherein the provisioning comprises:
during execution of the second action of the second job: executing the first action of the first job based at least on:
(a) determining, based on the first set of job dependency information, that executing the first job is not dependent on completion of the second job; and
(b) determining, based on the first set of resource requirement information, that the first action is not dependent on a different resource state of the first hardware resource than the second action;
wherein the method is performed by at least one device including a hardware processor.

2. The method of claim 1, further comprising:
accessing a set of subcomponent information indicating required resource states for the plurality of hardware resources when provisioning a plurality of hardware subcomponents of the hardware component;
generating the first set of resource requirement information based on the set of subcomponent information, wherein the generating comprises:
determining that the first action of the first job is to be executed on a first hardware subcomponent of the plurality of hardware subcomponents;
determining, based on the set of subcomponent information, that the first hardware subcomponent is dependent on the first resource state of the first hardware resource; and
storing, in the first set of resource requirement information, information indicating that the first action is dependent on the first resource state of the first hardware resource.

3. The method of claim 2, wherein determining that the first action of the first job is to be executed on the first hardware subcomponent is based on a set of code indicating operations to be performed for the first action.

4. The method of claim 1, wherein:
the first set of job dependency information indicates that executing a third job of the first plurality of jobs is not dependent on completion of the second job of the first plurality of jobs;
the first set of resource requirement information indicates that a third action of the third job is dependent on a second resource state of the first hardware resource; and
the provisioning further comprises:
during execution of at least one of the first action of the first job or the second action of the second job, delaying execution of the third action of the third job based at least on:
(a) determining, based on the first set of resource requirement information, that the third action is dependent on the second resource state of the first hardware resource;
(b) determining a current resource state of the first hardware resource; and
(c) determining that the second resource state of the first hardware resource differs from the current resource state of the first hardware resource.

5. The method of claim 4, further comprising:
responsive to determining that the second resource state differs from the current resource state: pausing a timeout counter associated with the third job until
(a) the current resource state of the first hardware resource matches the second resource state and
(b) the third action resumes execution.

6. The method of claim 1, further comprising:
prior to executing the second action of the second job: accessing a resource tracking system to determine a current resource state of the first hardware resource; and
determining if the current resource state of the first hardware resource matches the first resource state of the first hardware resource;
wherein executing the second action is contingent at least in part on the current resource state of the first hardware resource matching the first resource state of the first hardware resource.

7. The method of claim 6, further comprising:
responsive to determining that the current resource state of the first hardware resource matches the first resource state of the first hardware resource: executing the second action.

8. The method of claim 6, further comprising:
responsive to determining that the current resource state of the first hardware resource does not match the first resource state:
determining if the second action can execute based on the current resource state of the first hardware resource; and
responsive to determining that the second action can execute based on the current resource state of the first hardware resource: changing, in the resource tracking system, the current resource state of the first hardware resource to the first resource state.

9. The method of claim 1, further comprising:
determining that the first action of the first job has completed execution; and
responsive to determining that the first action of the first job has completed: changing, in a resource tracking system, a current resource state of the first hardware resource to indicate that the first hardware resource is available.

10. The method of claim 1, wherein the first resource state of the first hardware resource comprises one or more of: a particular host power state; a particular network interface card (NIC) power state; presence of a particular network connection; a particular head node box power state; or a particular tail node box power state.

11. The method of claim 1, wherein executing the first action of the first job is further based on one or more sequential execution criteria for determining a sequence of execution for a set of actions that are not delayed by respective unsatisfied dependencies.

12. One or more non-transitory computer readable media comprising instructions that, when executed by one or more hardware processors, cause performance of operations comprising:
accessing a first set of job dependency information indicating dependency relationships among a first plurality of jobs for provisioning a hardware component in a plurality of hardware components of a computer system, wherein the first set of job dependency information indicates that executing a first job of the first plurality of jobs is not dependent on completion of a second job of the first plurality of jobs;
accessing a first set of resource requirement information indicating dependency relationships between a first plurality of actions associated with the first plurality of jobs and a plurality of resource states of a plurality of hardware resources, wherein the first set of resource requirement information indicates that
(a) a first action of the first job is dependent on a first resource state of a first hardware resource in the plurality of hardware resources, and
(b) a second action of the second job is dependent on the first resource state of the first hardware resource;
provisioning a first instance of the hardware component, wherein the provisioning comprises:
during execution of the second action of the second job: executing the first action of the first job based at least on:
(a) determining, based on the first set of job dependency information, that executing the first job is not dependent on completion of the second job; and
(b) determining, based on the first set of resource requirement information, that the first action is not dependent on a different resource state of the first hardware resource than the second action.

13. The one or more non-transitory computer readable media of claim 12, the operations further comprising:
accessing a set of subcomponent information indicating required resource states for the plurality of hardware resources when provisioning a plurality of hardware subcomponents of the hardware component;
generating the first set of resource requirement information based on the set of subcomponent information, wherein the generating comprises:
determining that the first action of the first job is to be executed on a first hardware subcomponent of the plurality of hardware subcomponents;
determining, based on the set of subcomponent information, that the first hardware subcomponent is dependent on the first resource state of the first hardware resource; and
storing, in the first set of resource requirement information, information indicating that the first action is dependent on the first resource state of the first hardware resource.

14. The one or more non-transitory computer readable media of claim 12, wherein:
the first set of job dependency information indicates that executing a third job of the first plurality of jobs is not dependent on completion of the second job of the first plurality of jobs;
the first set of resource requirement information indicates that a third action of the third job is dependent on a second resource state of the first hardware resource; and
the provisioning further comprises:
during execution of at least one of the first action of the first job or the second action of the second job, delaying execution of the third action of the third job based at least on:
(a) determining, based on the first set of resource requirement information, that the third action is dependent on the second resource state of the first hardware resource;
(b) determining a current resource state of the first hardware resource; and
determining that the second resource state of the first hardware resource differs from the current resource state of the first hardware resource.

15. The one or more non-transitory computer readable media of claim 12, the operations further comprising:
prior to executing the second action of the second job: accessing a resource tracking system to determine a current resource state of the first hardware resource; and
determining if the current resource state of the first hardware resource matches the first resource state;
wherein executing the second action is contingent at least in part on the current resource state of the first hardware resource matching the first resource state of the first hardware resource.

16. The one or more non-transitory computer readable media of claim 15, the operations further comprising:
responsive to determining that the current resource state of the first hardware resource does not match the first resource state:
determining if the second action can execute based on the current resource state of the first hardware resource; and
responsive to determining that the second action can execute based on the current resource state of the first hardware resource: changing, in the resource tracking system, the current resource state of the first hardware resource to the first resource state.

17. A system comprising:
one or more hardware processors;
one or more non-transitory computer-readable media; and
program instructions stored on the one or more non-transitory computer-readable media that, when executed by the one or more hardware processors, cause the system to perform operations comprising:
accessing a first set of job dependency information indicating dependency relationships among a first plurality of jobs for provisioning a hardware component in a plurality of hardware components of a computer system, wherein the first set of job dependency information indicates that executing a first job of the first plurality of jobs is not dependent on completion of a second job of the first plurality of jobs;
accessing a first set of resource requirement information indicating dependency relationships between a first plurality of actions associated with the first plurality of jobs and a plurality of resource states of a plurality of hardware resources, wherein the first set of resource requirement information indicates that
(c) a first action of the first job is dependent on a first resource state of a first hardware resource in the plurality of hardware resources, and
(d) a second action of the second job is dependent on the first resource state of the first hardware resource;
provisioning a first instance of the hardware component, wherein the provisioning comprises:
during execution of the second action of the second job: executing the first action of the first job based at least on:
(a) determining, based on the first set of job dependency information, that executing the first job is not dependent on completion of the second job; and
(b) determining, based on the first set of resource requirement information, that the first action is not dependent on a different resource state of the first hardware resource than the second action.

18. The system of claim 17, the operations further comprising:
accessing a set of subcomponent information indicating required resource states for the plurality of hardware resources when provisioning a plurality of hardware subcomponents of the hardware component;
generating the first set of resource requirement information based on the set of subcomponent information, wherein the generating comprises:
determining that the first action of the first job is to be executed on a first hardware subcomponent of the plurality of hardware subcomponents;
determining, based on the set of subcomponent information, that the first hardware subcomponent is dependent on the first resource state of the first hardware resource; and
storing, in the first set of resource requirement information, information indicating that the first action is dependent on the first resource state of the first hardware resource.

19. The system of claim 17, wherein:
the first set of job dependency information indicates that executing a third job of the first plurality of jobs is not dependent on completion of the second job of the first plurality of jobs;
the first set of resource requirement information indicates that a third action of the third job is dependent on a second resource state of the first hardware resource; and
the provisioning further comprises:
during execution of at least one of the first action of the first job or the second action of the second job, delaying execution of the third action of the third job based at least on:
(a) determining, based on the first set of resource requirement information, that the third action is dependent on the second resource state of the first hardware resource;
(b) determining a current resource state of the first hardware resource; and
(c) determining that the second resource state of the first hardware resource differs from the current resource state of the first hardware resource.

20. The system of claim 17, the operations further comprising:
prior to executing the second action of the second job: accessing a resource tracking system to determine a current resource state of the first hardware resource; and
determining if the current resource state of the first hardware resource matches the first resource state of the first hardware resource;
wherein executing the second action is contingent at least in part on the current resource state of the first hardware resource matching the first resource state of the first hardware resource.
